(19) United States
(12) Patent Application Publication
(10) Pub. No.: US 2022/0292127 A1
(43) Pub. Date: Sep. 15, 2022

(54) INFORMATION MANAGEMENT SYSTEM

(71) Applicant: Honda Motor Co., Ltd., Tokyo (JP)

(72) Inventor: Daisuke SAKAMOTO, Tokyo (JP)

(73) Assignee: Honda Motor Co., Ltd., Tokyo (JP)

(21) Appl. No.: 17/680,333

(22) Filed: Feb. 25, 2022

(30) Foreign Application Priority Data
Mar. 9, 2021 (JP) 2021-037110

(51) Int. Cl. G06F 16/35; G06F 40/279; G06F 40/58

(52) U.S. Cl. CPC G06F 16/355; G06F 40/279; G06F 40/58

(57) ABSTRACT

An information management system is provided. Based on a designated item (an entity (first designated element item) and a keyword (second designated element item)) inputted through an input interface, a designated text group which is a part of a secondary text group is searched from a database and saved to a queue. Further, designated texts of a designated number are extracted from the designated text group preferentially in an order according to one designated priority item among a plurality of designated priority items (sensitivity amount and latest information (information freshness)). Then, a first report showing a time series of an occurrence frequency of the designated texts of the designated number is outputted on an output interface.

### CROSS-REFERENCE TO RELATED APPLICATION

This application claims the priority benefit of Japan application serial no. 2021-037110, filed on Mar. 9, 2021. The entirety of the above-mentioned patent application is hereby incorporated by reference herein and made a part of this specification.

### BACKGROUND

### Technical Field

The disclosure relates to a system which searches information from a database.

### Description of Related Art

To be able to estimate sensitivity characteristics of users at high accuracy, a technical method has been proposed to determine a user's sensitivity characteristics with respect to a keyword based on a search log about a specific keyword and the user's search history (see, for example, Patent Document 1: Japanese Patent Application Laid-Open No. 2017-027359).

With respect to a theme and/or a genre of particular interest to users on the Internet, a technical method capable of sharing and transmitting information that can be covered in a timely manner with good quality has been proposed (see, for example, Patent Document 2: Japanese Patent Application Laid-Open No. 2013-065272). Specifically, four axes of quality, time, space, and commonality and their coordinates, which represent a four-dimensional space of information as an information map, and a database and information space MAP linked to the four axes are constructed.

A technical method as described below has been proposed. It is possible to extract products with design attributes close to a design search request of a product, and by repeating reference, purchase, and evaluation from the results searched according to a design search condition, an evaluation value of a design attribute for each product is acquired, and a design attribute that reflects an objective evaluation is acquired (see, for example, Patent Document 3: Japanese Patent Application Laid-Open No. 2012-079028).

A technical method has been proposed to enable a sensitivity search for an aspect to which a sensitivity expression inputted as a search condition belongs and improve search accuracy by preventing images related to completely different aspects from becoming noise (see, for example, Patent Document 4: Japanese Patent Application Laid-Open No. 2011-048527). Specifically, when managing information using sensitivity expressions that represent an image of a search target, for a search that takes into account various aspects of the search target such as quality, appearance characteristics, and personality, a sensitivity expression is extracted from a text set and is linked to the search target. With these being taken as inputs, a sensitivity expression DB1 which stores sensitivity information for the sensitivity expression and side information to which the sensitivity expression belongs is used, and the sensitivity information is generated for each side information for the search target and then stored in a search target DB2.

A technical method has been proposed to enable a search from a sensitivity expression and/or a target word related to one target (see, for example, Patent Document 5: Japanese Patent Application Laid-Open No. 2010-272075). Specifically, by simply inputting a sensitivity expression or a search target word, a search result that is close to the input in terms of sensitivity can be obtained. In addition, to realize a sensitivity search that does not require addition of metadata related to the target, with text analysis and the target word list being taken as inputs, a sensitivity expression is extracted from the text according to a sensitivity expression dictionary and a sensitivity expression extraction rule. It is linked to the target word in the list, the sensitivity expressions are aggregated for each target word, and a sensitivity vector dictionary is used to generate sensitivity information for each target word.

A technical method has been proposed to enable a data search only by inputting subjective evaluation scores, even for a target for which it is difficult to extract objective numerical values associated with subjective evaluation criteria (see, for example, Patent Document 6: Japanese Patent Application Laid-Open No. H09-006802). An evaluation score input is received from an evaluator, a set of data of an evaluator identifier and an evaluation score inputted by the evaluator, and between-evaluator difference data showing different assignment methods of evaluation scores among the evaluators are corrected, a sensitivity database is searched based on a search condition generated according to the corrected result, and the search result is displayed.

However, no method has been established to help learn about an occurrence pattern of a text group searched from a database constructed based on texts issued in relation to the plurality of entities.

### SUMMARY

An information management system according to an embodiment of the disclosure includes a first input processing element, a second input processing element, a first output processing element, and a second output processing element. The first input processing element performs a designated filter process on public information related to each of a plurality of entities to acquire a primary text group composed of a plurality of primary texts respectively described in a plurality of different languages, and translates at least a part of the primary texts constituting the primary text group into a designated language to convert the primary text group into a secondary text group composed of a plurality of secondary texts described in the designated language. The second input processing element extracts sensitivity information respectively from each of the plurality of secondary texts constituting the secondary text group and classifies the sensitivity information into each of a plurality of sensitivity categories, and then constructs a database in which the sensitivity information respectively classified into each of the plurality of sensitivity categories and each of the plurality of secondary texts are associated with each other. Based on a designated item inputted through an input interface, the first output processing element searches for a designated text group that is a part of the secondary text group from the database constructed by the second input processing element and then saves the designated text group to a queue. The second output processing element extracts designated texts of a designated number from the designated text group preferentially in an order according to one designated priority item designated among a plurality of different designated priority items through the input interface, and outputs a first report including a time series of an occurrence frequency of the designated texts of the designated number on an output interface.

According to the information management system having the above configuration, among public information related to a plurality of entities, at least a part of primary texts among a plurality of primary texts constituting a primary text group described respectively in a plurality of different languages is translated into a designated language. “Entity” is a concept including a juridical person, or an organization that does not have juridical personality, and/or an individual. “Text group” may be composed of a plurality of texts or may be composed of one text.

Herein, the primary texts originally described in the designated language do not need to be translated into the designated language. As a result, the primary text group composed of the plurality of primary texts is converted into a secondary text group composed of a plurality of secondary texts described in the designated language. Then, each of the plurality of secondary texts is associated with sensitivity information extracted from each of the plurality of secondary texts and a sensitivity category of the sensitivity information to construct a database. Since the database is constructed based on a plurality of different languages, the amount of information in the database is increased, and thus the usefulness and convenience are improved.

Based on a designated item inputted through the input interface, a designated text group which is a part of the secondary text group is searched from the database and then saved to a queue. “Queue” refers to a storage area allocated in a memory (internal memory) and/or a database (external memory) that can be read or searched by the information management system. Further, designated texts of a designated number are extracted from the designated text group preferentially in an order according to one designated priority item designated among a plurality of designated priority items, and a first report is outputted on the output interface. Accordingly, it is possible to enable the user in contact with the output interface to learn about a time series of an occurrence frequency of the designated texts of the designated number.

In the information management system having the above configuration according to an embodiment, when a number of the designated texts constituting the designated text group is equal to or greater than a threshold value, the first output processing element may aggregate overlapping designated texts which are a part of the designated text group so that the number is less than the threshold value.

According to the information management system having the above configuration, while avoiding a situation in which the size of the designated text group and the number of the designated texts constituting the designated text group become excessive, it is possible to enable the user in contact with the first report outputted on the output interface to learn about a time series of an occurrence frequency of the designated texts.

In the information management system having the above configuration according to an embodiment, the first output processing element may search for a first designated text group which is a part of the secondary text group from the database and then save the first designated text group to a first queue based on a first designated item taken as the designated item, and search for a second designated text group which is a part of the first designated text group and then save the second designated text group to a second queue based on the first designated item and a second designated item taken as the designated item. The second output processing element may extract the designated texts of the designated number from the designated text group derived from the first designated text group preferentially in an order according to a first designated priority item taken as the designated priority item, and extract the designated texts of the designated number from the designated text group derived from the second designated text group preferentially in an order according to a second designated priority item taken as the designated priority item.

According to the information management system having the above configuration, components of the designated text group as the extraction result according to the designated priority item may be appropriately selected according to the designated priority item, and on this basis, it is possible to enable the user in contact with the first report to learn about a time series of an occurrence frequency of the designated texts which are the components.

In the information management system having the above configuration according to an embodiment, the second output processing element may output, on the output interface, the first report further including an occurrence frequency of sensitivity information extracted from the designated texts of the designated number for each of the sensitivity categories.

According to the information management system having the above configuration, in addition to the time series of the occurrence frequency of the designated texts, it is possible to enable the user in contact with the first report to learn about an occurrence frequency of sensitivity information extracted from the designated texts of the designated number for each sensitivity category.

In the information management system having the above configuration according to an embodiment, the second output processing element may output, on the output interface, the first report further including a word cloud according to words extracted in a descending order of an occurrence frequency in the designated texts of the designated number.

According to the information management system having the above configuration, in addition to the time series of the occurrence frequency of the designated texts, it is possible to enable the user in contact with the first report to learn about the words (topics) having a relatively high occurrence frequency in the designated texts of the designated number.

In the information management system having the above configuration according to an embodiment, based on a part of designated element items among a plurality of designated element items constituting the designated item, the first output processing element may search for a target text group which is a part of the secondary text group from the database, and generate a probability density function of an occurrence frequency of target texts constituting the target text group based on a histogram of the occurrence frequency of the target texts. On a condition that a probability of an occurrence frequency of first target texts constituting a first target text group according to the probability density function is less than or equal to a reference value, the second output processing element may output, on the output interface, a second report including a time series of the occurrence frequency of the first target texts including a time period in which the occurrence frequency of the first target texts has increased sharply.

According to the information management system having the above configuration, based on a part of designated element items among a plurality of designated element items constituting the designated item, a target text group which is a part of the secondary text group is searched from the database. Accordingly, although narrowed down from all occurring texts by a part of designated element items, a text group larger than the designated text group (and including the designated text group) is extracted as a target text group as there are no restrictions of designated element items other than the part of designated element items.

Further, based on a histogram of an occurrence frequency of target texts constituting the target text group, a probability density function of the occurrence frequency of the target texts is generated. Further, on the condition that the probability of an occurrence frequency of first target texts constituting a first target text group according to the probability density function is less than or equal to a reference value, it is determined that the occurrence frequency of the first target texts has increased sharply. The first target text group is another target text group which occurs after the target text group used for generating the probability density function. Then, a second report showing a time series of an occurrence frequency of the first target texts including a time period in which the occurrence frequency of the first target texts has increased sharply is outputted on the output interface. Accordingly, it is possible to enable the user in contact with the output interface to learn about the time series of the occurrence frequency of the first target texts and further learn about the time period in which the occurrence frequency of the first target texts has increased sharply.

In the information management system having the above configuration according to an embodiment, the first output processing element may generate a plurality of the probability density functions respectively for a plurality of different unit periods. On a condition that the probability according to the probability density function corresponding to a time period in which the first target text group occurs is equal to or less than the reference value, the second output processing element may determine that the occurrence frequency of the first target texts has increased sharply and output the second report including a time series of the occurrence frequency of the first target texts on the output interface.

According to the information management system having the above configuration, considering that the time change pattern of the occurrence frequency of the target texts generally differs depending on the time period, a probability density function appropriate for the time period in which the first target text group occurs is used. Therefore, it is possible to improve the accuracy of determining whether the occurrence frequency of the first target texts has increased sharply.

In the information management system having the above configuration according to an embodiment, on a condition that an occurrence frequency of second target texts constituting a second target text group which is a part of the target text group is equal to or greater than a second predetermined value, the second output processing element may output the second report including a time series of the occurrence frequency of the first target texts on the output interface. The second target texts contain words whose occurrence frequency in the first target text group is equal to or greater than a first predetermined value.

According to the information management system having the above configuration, the first target text group is reduced to the second target text group according to a word (topic) appropriate for describing the first target text group. Therefore, it is possible to improve the accuracy of determining whether the occurrence frequency of the first target texts has increased sharply due to the topic according to the magnitude of the occurrence frequency of the second target texts constituting the second target text group.

In the information management system having the above configuration according to an embodiment, the second output processing element may output, on the output interface, the second report further including an occurrence frequency of sensitivity information extracted from the second target text group for each of the sensitivity categories.

According to the information management system having the above configuration, in addition to the time series of the occurrence frequency of the first target texts including the time period in which the occurrence frequency of the first target texts has increased sharply, it is possible to enable the user in contact with the second report to learn about an occurrence frequency of the sensitivity information extracted from the second target text group for each sensitivity category.

In the information management system having the above configuration according to an embodiment, the second output processing element may output, on the output interface, the second report further including a word cloud according to words extracted in a descending order of an occurrence frequency in the first target text group.

According to the information management system having the above configuration, in addition to the time series of the occurrence frequency of the first target texts including the time period in which the occurrence frequency of the first target texts has increased sharply, it is possible to enable the user in contact with the second report to learn about the words (topics) having a relatively high occurrence frequency in the first target text group, and thus learn about the topic from which the sharp increase has arisen.

In the information management system having the above configuration according to an embodiment, after removing noise from each of the plurality of secondary texts, the second input processing element may construct a database by associating the sensitivity information with each of the plurality of secondary texts from which the noise has been removed.

According to the information management system having the above configuration, it is possible to improve the usefulness of a database composed of the secondary text group from which noise is removed, and thus improve the usefulness of the information derived from the designated text group searched from the database.

### BRIEF DESCRIPTION OF THE DRAWINGS

FIG. 1 is a view showing a configuration of an information management system as an embodiment of the disclosure.

FIG. 2 is a flowchart showing a database construction method.

FIG. 3 is a view illustrating a database construction method. English translations respectively corresponding to Japanese texts No. 1 to No. 8 are provided at the lower right corner of FIG. 3 as reference.

FIG. 4 is a first flowchart relating to a notification method of a text occurrence frequency.

FIG. 5 is a second flowchart relating to a notification method of a text occurrence frequency.

FIG. 6 is a first flowchart relating to a notification method of a sharp increase in a text occurrence frequency.

FIG. 7 is a second flowchart relating to a notification method of a sharp increase in a text occurrence frequency.

FIG. 8 is a third flowchart relating to a notification method of a sharp increase in a text occurrence frequency.

FIG. 9A is view illustrating an input interface for keyword designation.

FIG. 9B is a view illustrating an input interface for sensitivity category designation.

FIG. 10 is a view illustrating a first report showing an occurrence frequency of designated texts.

FIG. 11A is a histogram of a text occurrence frequency in one time period.

FIG. 11B is a histogram of a text occurrence frequency in another time period.

FIG. 12 is a view illustrating a second report showing an occurrence frequency of target texts.

### DESCRIPTION OF THE EMBODIMENTS

Embodiments of the disclosure provide an information management system capable of improving the usefulness of information extracted from a text group related to each of a plurality of entities. Hereinafter, the embodiments of the disclosure will be described with reference to the drawings.

### Configuration

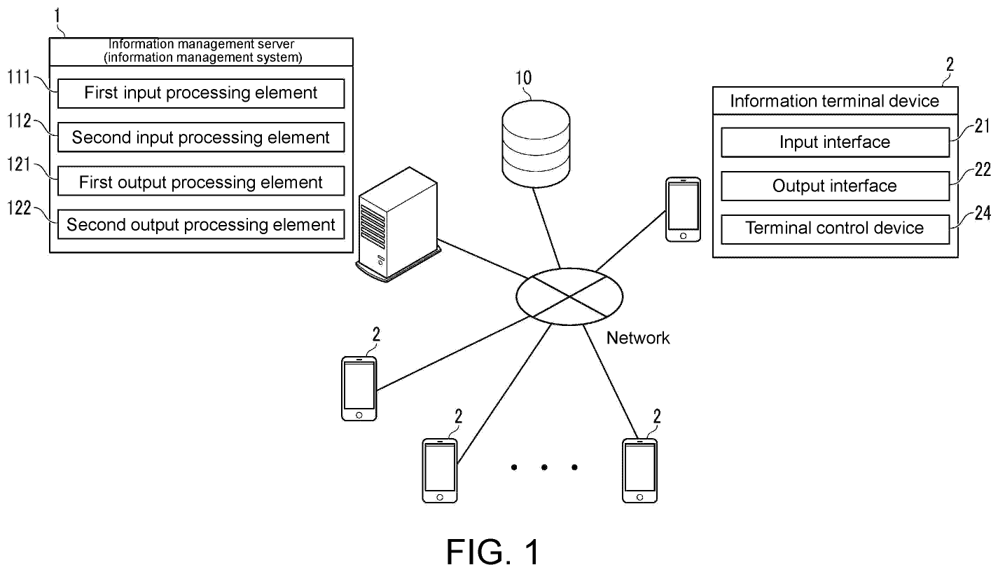

An information management system as an embodiment of the disclosure as shown in FIG. 1 is configured by an information management server 1 capable of communicating with an information terminal device 2 and a database server 10 via a network. The database server 10 may also be a component of the information management server 1.

The information management server 1 includes a first input processing element 111, a second input processing element 112, a first output processing element 121, and a second output processing element 122. Each of the elements 111, 112, 121, and 122 is configured by an arithmetic processing device (configured by hardware such as a CPU, a single-core processor, and/or a multi-core processor) which reads necessary data and program (software) from a storage device (configured by a memory such as a ROM, a RAM, and an EEPROM, or hardware such as an SSD and an HDD), and then executes arithmetic processing on the data according to the program.

The information terminal device 2 is configured by a portable terminal device such as a smartphone, a tablet terminal device, and/or a notebook computer, and may also be configured by a stationary terminal device such as a desktop computer. The information terminal device 2 includes an input interface 21, an output interface 22, and a terminal control device 24. The input interface 21 may be configured by, for example, a touch panel-type button and a voice recognition device having a microphone. The output interface 22 may be configured by, for example, a display device constituting a touch panel and an audio output device. The terminal control device 24 is configured by an arithmetic processing device (configured by hardware such as a CPU, a single-core processor, and/or a multi-core processor) which reads necessary data and program (software) from a storage device (configured by a memory such as a ROM, a RAM, and an EEPROM, or hardware such as an SSD and an HDD), and then executes arithmetic processing on the data according to the program.

### First Function

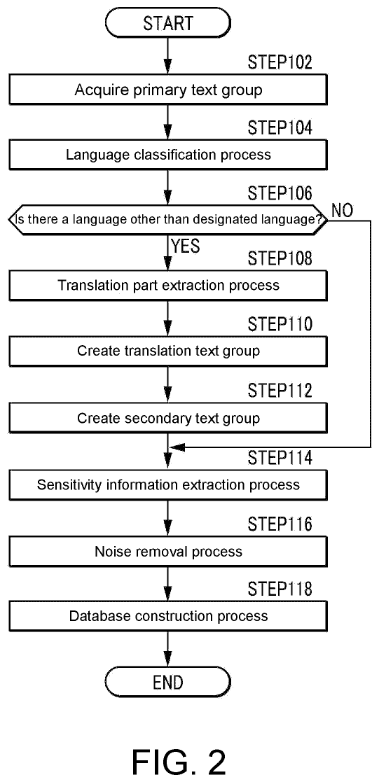

As a first function of the information management system having the above configuration, a database construction function will be described with reference to the flowchart of FIG. 2. A series of processes related to the first function may be repeatedly executed periodically (e.g., every 60 minutes).

The first input processing element 111 performs a designated filter process on public information related to each of a plurality of entities to acquire a primary text group composed of a plurality of primary texts described respectively in a plurality of different languages (FIG. 2/STEP102).

“Public information” is acquired via the network from designated media such as mass media (e.g., TV, radio, and newspapers), network media (e.g., electronic bulletin boards, blogs, and social networking services (SNS)), and multimedia. The primary text is attached with a time stamp indicating a characteristic time point, such as a time point when the primary text is posted, a time point when the primary text is published, and/or a time point when the primary text is edited.

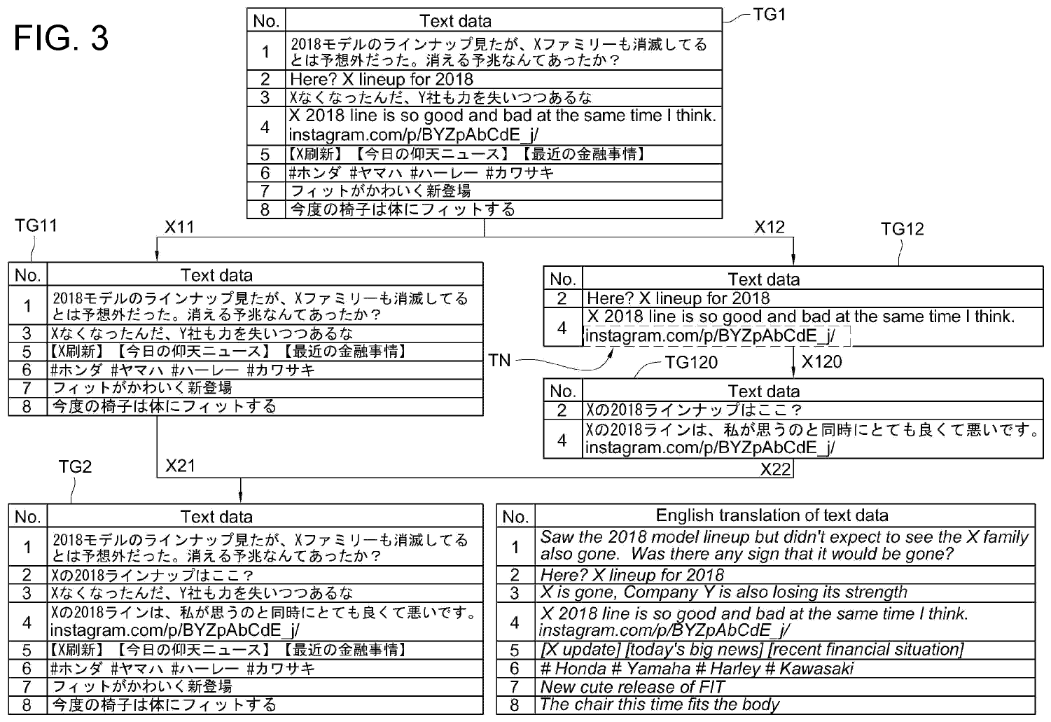

Accordingly, for example, as shown in FIG. 3, text data in which a primary text group TG1 composed of eight primary texts contains vehicle-related terms is acquired. The primary text data is, for example, a text associated with a vehicle, in which “X” represents the name/abbreviation of the vehicle and “Y” represents the name/abbreviation of the vehicle manufacturing company. English translations respectively corresponding to Japanese texts No. 1 to No. 8 in text groups TG1, TG11, TG120, and TG2 are provided at the lower right corner of FIG. 3 as reference for understanding the embodiment of the disclosure. In addition, the vehicle-related terms are terms in vehicle-related fields such as motorcycles and four-wheeled vehicles, and specifically, vehicle names, vehicle manufacturing company names, president names of vehicle manufacturing companies, vehicle parts terms, vehicle competition terms, racer names, and the like correspond to the vehicle-related terms. In addition to selectively acquiring a primary text group associated with one designated field such as a vehicle-related field, a clothing-related field, a grocery-related field, and a toy-related field, a primary text group associated with a plurality of designated fields may also be acquired.

Next, the first input processing element 111 executes a language classification process on the primary text group (FIG. 2/STEP104). Specifically, the primary texts constituting the primary text group are classified into texts in a designated language (e.g., Japanese, English, Chinese, etc.) and texts in a language other than the designated language. Accordingly, for example, the primary text group TG1 shown in FIG. 3 is classified into a primary text group TG11 in Japanese, which is the designated language, and a primary text group TG12 in a language such as English other than the designated language (see FIG. 3/arrow X11 and arrow X12). The language other than the designated language may include not only one language but also a plurality of languages.

When the primary text group data is classified as described above, the first input processing element 111 determines whether there is a primary text in a language other than the designated language (FIG. 2/STEP106). When the determination result is negative (FIG. 2/STEP106 . . . NO), i.e., when the primary text group is composed only of primary texts described in the designated language, a sensitivity information extraction process is executed on the primary text group (FIG. 2/STEP114).

On the other hand, when the determination result is positive (FIG. 2/STEP106 . . . YES), the first input processing element 111 executes a translation part extraction process which extracts, as a translation part, a part requiring translation from the primary text in a language other than the designated language (FIG. 2/STEP108). Accordingly, for example, among the primary texts constituting the primary text group TG12 in a language other than the designated language as shown in FIG. 3, the part excluding URL data (see the part surrounded by a broken line TN) is extracted as the translation part.

Subsequently, the first input processing element 111 executes a machine translation process on the translation part to generate a translation text group (FIG. 2/STEP110). Accordingly, for example, by machine-translating the translation part (the part excluding the URL data) among the primary texts constituting the primary text group TG12 in a language other than the designated language as shown in FIG. 3, a translation text group TG120 is obtained (see FIG. 3/arrow X120).

Then, the first input processing element 111 integrates the primary text group and the translation text group in the designated language to generate a secondary text group composed of secondary texts (FIG. 2/STEP112). Accordingly, for example, by integrating the primary text group TG11 and the translation text group TG120 in the designated language as shown in FIG. 3, a secondary text group TG2 composed of 8 texts, i.e., the same number as the texts of the primary text group TG1, is created (see FIG. 3/arrow X21 and arrow X22). When the primary text group does not include a primary text described in a language other than the designated language, the primary text group is directly generated as the secondary text group.

Subsequently, the second input processing element 112 executes a sensitivity information extraction process from each of the secondary texts constituting the secondary text group (FIG. 2/STEP114). At this time, an analysis part requiring analysis is extracted from the secondary text group or each of the secondary texts constituting the secondary text group. For example, a secondary text that is merely a list of titles and nouns is excluded from the analysis part. According to a language comprehension algorithm for understanding/determining a construction of the secondary text and/or a connection relationship of words included in the secondary text, sensitivity information is extracted from the analysis part, and the sensitivity information is classified into each of a plurality of sensitivity categories.

For example, the sensitivity information is classified in two stages into three upper sensitivity categories “Positive”, “Neutral”, and “Negative” and into lower sensitivity categories of the upper sensitivity category. For example, “happy” and “want to buy” correspond to lower sensitivity categories of the upper sensitivity category “Positive”. “Surprise” and “solicitation” correspond to lower sensitivity categories of the upper sensitivity category “Neutral”. “Angry” and “don't want to buy” correspond to lower sensitivity categories of the upper sensitivity category “Negative”.

The second input processing element 112 executes a noise removal process on the secondary text group (FIG. 2/STEP116). Specifically, a morphological analysis is performed on the secondary text. Further, when a designated noun of a vehicle-related term is contained in the secondary text, it may be determined whether the data is noise data based on a part of speech of the word following the designated noun. For example, in Japanese, when the part of speech of the word following the designated noun contained in the secondary text is a case particle, and the case particle indicates any of the subjective case, the objective case, and the possessive case, it is determined that the secondary text is not noise. On the other hand, in other cases, it is determined that the secondary text is noise. Then, the secondary text determined to be noise is removed from the secondary text group. The noise removal process may also be omitted.

For example, although the secondary text “No. 8” constituting the secondary text group TG2 shown in FIG. 3 contains the product name “ [symbol] ” (English translation: fit) as a noun, since the word following the noun is not a case particle but a verb “ [symbol] ” (English translation: do), this secondary text is determined to be noise and is removed from the secondary text group TG2.

Then, the second input processing element 112 associates each of the secondary texts constituting the secondary text group with the sensitivity information classified into the sensitivity category extracted from the secondary text to construct a database (FIG. 2/STEP118). The constructed database is generated as a database configured by the database server 10 shown in FIG. 1. At this time, data may be exchanged between the information management server 1 and the database server 10 via the network.

### Second Function

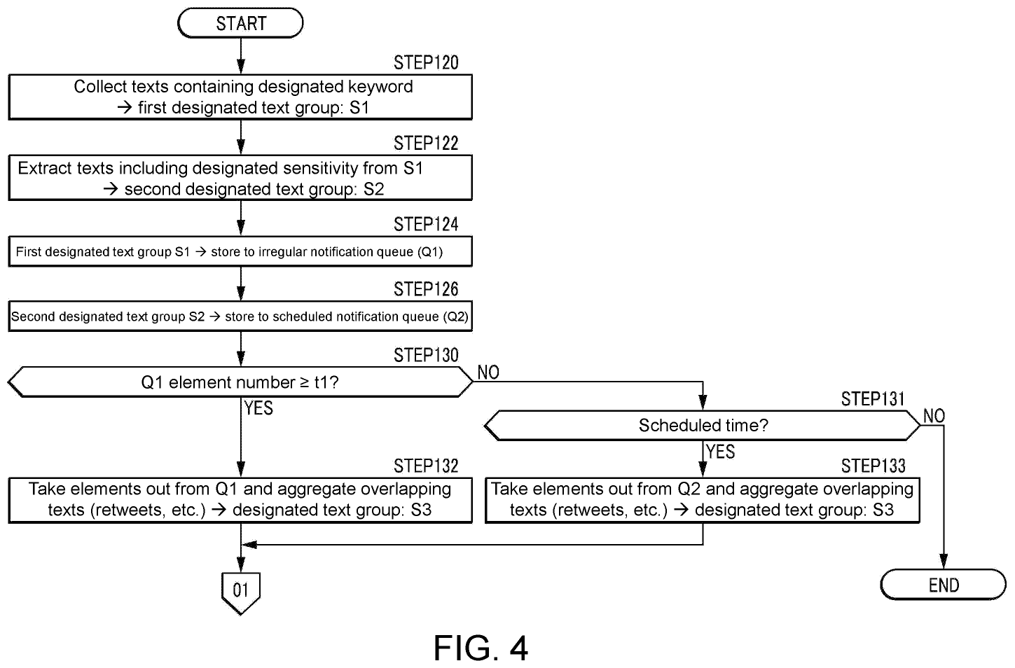

As a second function of the information management system having the above configuration, an information management function will be described with reference to the flowcharts of FIG. 4 to FIG. 8.

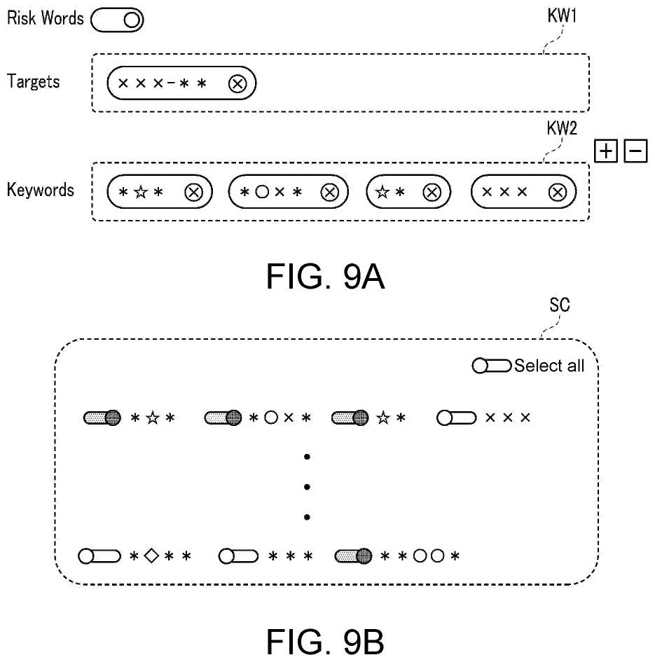

The first output processing element 121 extracts a set of texts containing a designated keyword as a first designated text group S1 from the secondary text group stored in the database (FIG. 4/STEP120). The designated keyword is designated or inputted by the user through the input interface 21 of the information terminal device 2 and is acquired based on communication with the information terminal device 2. For input of the keyword, for example, as shown in FIG. 9A, an input field KW1 for selecting or designating one or more entities (primary keyword) and an input field KW2 for selecting or designating one or more detail keywords (secondary keyword) may be outputted on the output interface 22.

The first output processing element 121 searches, from the database, for a set of texts including a designated sensitivity category from among the first designated text group Si as a second designated text group S2 (FIG. 4/STEP122). The designated sensitivity category is designated or inputted by the user through the input interface 21 of the information terminal device 2 and is acquired based on communication with the information terminal device 2. For input of the sensitivity category, for example, as shown in FIG. 9B, an input field SC for selecting or designating one or more upper sensitivity categories and/or one or more lower sensitivity categories may be outputted on the output interface 22. In the example shown in FIG. 9B, each lower sensitivity category is selected by sliding a button corresponding to the lower sensitivity category from the left side to the right side.

The first output processing element 121 stores the first designated text group S1 to an irregular notification queue Q1 (FIG. 4/STEP124). The second designated text group S2 is stored to a scheduled notification queue Q2 (FIG. 4/STEP126).

The first output processing element 121 determines whether a number of elements stored in the irregular notification queue Q1 is equal to or greater than a first threshold value t1 (FIG. 4/STEP130). When the determination result is positive (FIG. 4/STEP130 . . . YES), elements are taken out from the irregular notification queue Q1, and overlapping parts of the elements are aggregated to generate a designated text group S3 (FIG. 4/STEP132).

On the other hand, when the determination result is negative (FIG. 4/STEP130 . . . NO), the first output processing element 121 further determines whether a current time has become a scheduled time (FIG. 4/STEP131). When it is determined that the current time has not become the scheduled time (FIG. 4/STEP131 . . . NO), the series of processes is ended. The scheduled time may be designated or inputted by the user through the input interface 21 of the information terminal device 2 and may be acquired based on communication with the information terminal device 2. Either the processes of STEP130 and STEP132 or the processes of STEP131 and STEP133 may be omitted. When it is determined that the current time has become the scheduled time (FIG. 4/STEP131 . . . YES), the first output processing element 121 takes out elements from the scheduled notification queue Q2 and aggregates overlapping parts of the elements to generate a designated text group S3 (FIG. 4/STEP133).

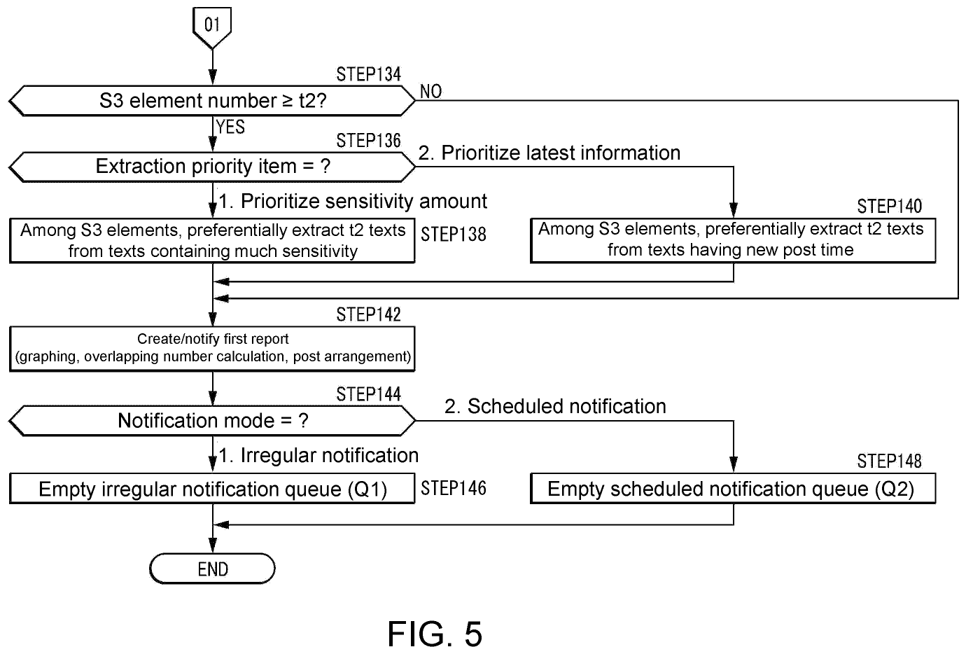

Subsequently, the second output processing element 122 determines whether a number of components of the designated text group S3 is equal to or greater than a second threshold value t2 (FIG. 5/STEP134). When the determination result is negative (FIG. 5/STEP134 . . . NO), a first report creation/notification process to be described later is executed (FIG. 5/STEP142).

On the other hand, when the determination result is positive (FIG. 5/STEP134 . . . YES), the first output processing element 121 further determines a priority item for selecting texts from the designated text group S3 (FIG. 5/STEP136). The priority item is designated or inputted by the user through the input interface 21 of the information terminal device 2 and is acquired based on communication with the information terminal device 2.

When it is determined that the priority item is a “sensitivity amount” (FIG. 5/STEP136 . . . 1), from a plurality of designated texts which are components of the designated text group S3, the second output processing element 122 extracts designated texts of a same number as the second threshold value t2 preferentially in a descending order of the amount of sensitivity information contained (FIG. 5/STEP138).

When it is determined that the priority item is “latest information” (FIG. 5/STEP136 . . . 2), from the plurality of designated texts which are components of the designated text group S3, the second output processing element 122 extracts designated texts of a same number as the second threshold value t2 preferentially in a descending order of newness of the post time (FIG. 5/STEP140).

Subsequently, the second output processing element 122 creates a first report, notifies to the information terminal device 2 via the network, and outputs the first report on the output interface 22 of the information terminal device 2 (FIG. 5/STEP142).

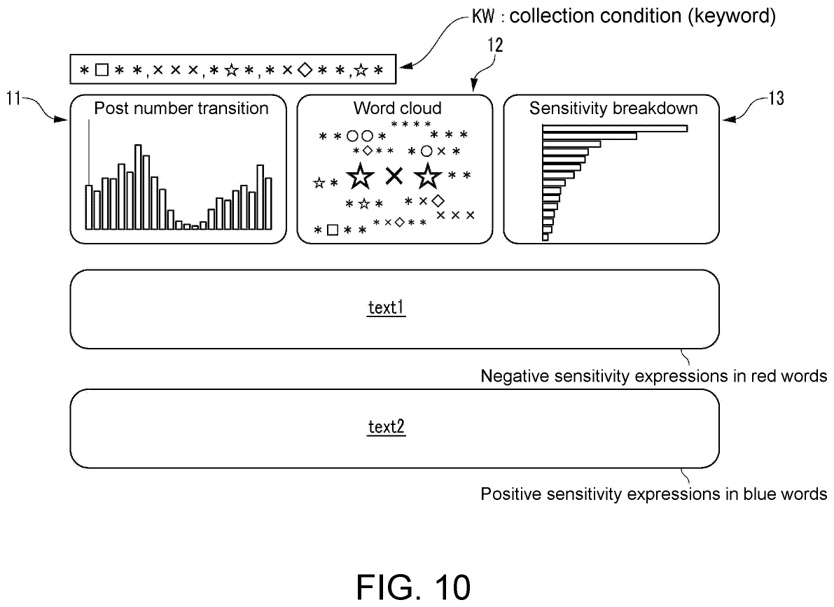

Accordingly, for example, as shown in FIG. 10, a bar graph I1 which shows a time series (e.g., every 30 minutes) of an occurrence frequency of the designated texts in a most recent designated period (e.g., one day), a word cloud I2 in which words that are preferentially extracted in a descending order of a count of being contained in the designated texts are randomly arranged, and a bar graph I3 which shows an occurrence frequency of the sensitivity information for each lower sensitivity category are outputted on the output interface 22. On the output interface 22, each bar constituting the bar graph I3 may be outputted in an identifiable manner by a difference in color or the like according to a difference in the lower sensitivity category or the upper sensitivity category to which the lower sensitivity category belongs.

In addition, as shown in FIG. 10, a part of the extracted designated texts text1, text2, . . . may be outputted on the output interface 22. On the output interface 22, words corresponding to the sensitivity information constituting the designated texts text1, text2, . . . may be outputted in an identifiable manner by a difference in color or the like according to a difference in the upper sensitivity category and/or the lower sensitivity category.

Next, the second output processing element 122 determines a notification mode (FIG. 5/STEP144). The notification mode is designated or inputted by the user through the input interface 21 of the information terminal device 2 and is acquired based on communication with the information terminal device 2.

When it is determined that the notification mode is “irregular notification” (FIG. 5/STEP144 . . . 1), the first output processing element 121 deletes the first designated text group S1 from the irregular notification queue Q1 (FIG. 5/STEP146). Further, when it is determined that the notification mode is “scheduled notification” (FIG. 5/STEP 144 . . . 2), the first output processing element 121 deletes the second designated text group S2 from the scheduled notification queue Q2 (FIG. 5/STEP148).

### Calculation of Steady State

Since the post number on the SNS is correlated with the time period (there are time periods of many posts and time periods of few posts even if there are no special events), a steady state is calculated for each time period, and an abnormal post number is detected based thereon. Data collection is automatically performed periodically (currently every 30 minutes).

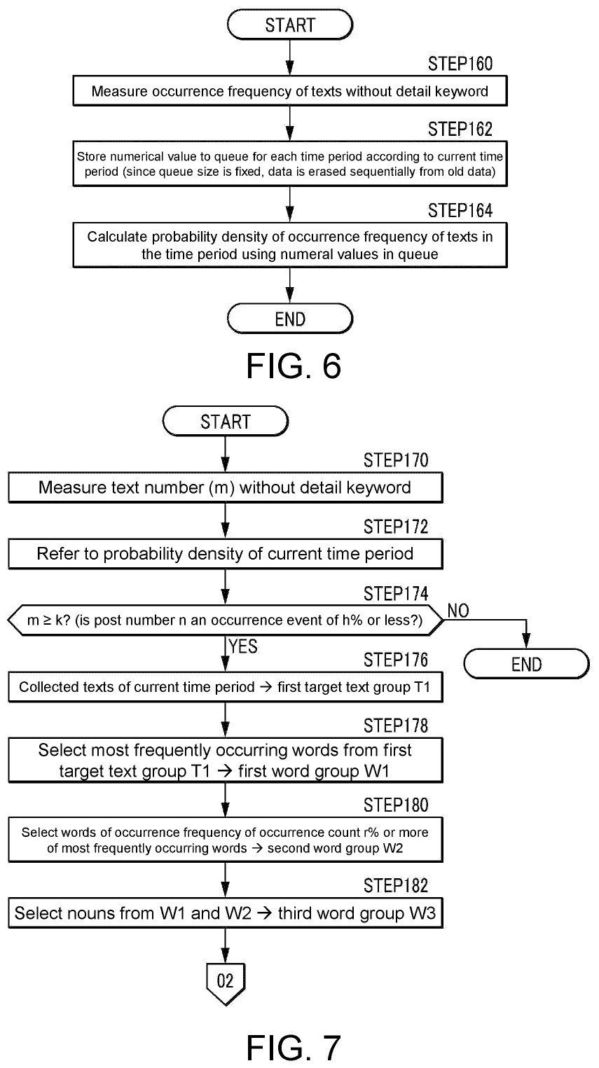

Specifically, first, the first output processing element 121 measures an occurrence frequency (e.g., a post number on the SNS) of target texts in a time series without a detail keyword (FIG. 6/STEP160). Since it is not possible to inexhaustibly collect SNS posts in the world, posts are generally collected by a loose filter according to a name (first designated element item) of a company (entity) such as “Honda” and “Toyota”. “Without a detail keyword” means that no keywords (second designated element item) or keyword filters for further selection/extraction are used on the above collected data.

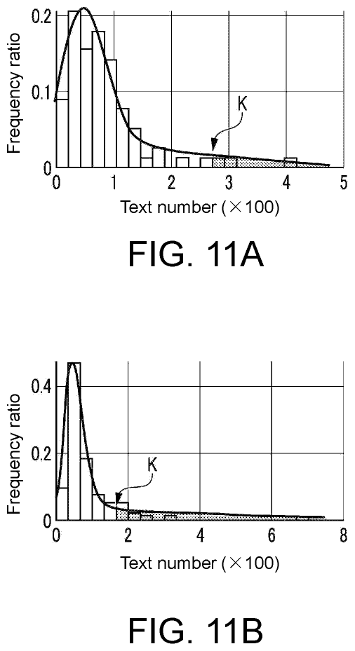

The first output processing element 121 stores numerical values to the queue for each time period (FIG. 6/STEP 162). Since the size of the queue is limited, the data stored in the queue is erased sequentially from the oldest to the newest. Accordingly, for example, as respectively shown in FIG. 11A and FIG. 11B, for each of the different time periods, a histogram in which the horizontal axis represents a target text occurrence frequency and the vertical axis represents a frequency ratio is generated.

The first output processing element 121 calculates a probability density function of an occurrence frequency (e.g., a post number on the SNS) of target texts in the time period using the information stored in the queue (FIG. 6/STEP164). For example, with outliers or singular values excluded from the bar graphs respectively shown in FIG. 11A and FIG. 11B, the probability density function is generated by curve fitting so that the area under the curve becomes 1 (see curves in FIG. 11A and FIG. 11B).

### Sharp Increase Detection

When the occurrence frequency of the target texts is a number (large number) that occurs only at a specific probability or less, this is first detected as a sharp increase. The detection process is automatically executed periodically (currently every 30 minutes).

Specifically, the second output processing element 122 measures an occurrence frequency m of the target texts stored in the database without a keyword (FIG. 7/STEP170). Further, a probability density of the current time period is referred to (FIG. 7/STEP172).

The second output processing element 122 determines whether the occurrence frequency m of the target texts is equal to or greater than a threshold value k (whether the probability of the occurrence frequency n of the target texts is an occurrence event of a reference value h or less corresponding to the threshold value k) (FIG. 7/STEP174). When a post number occurring at a probability of the reference value h (e.g., h=0.05) or less is generated in a sharp increase, for example, a value at which the area of the hatched region respectively in FIG. 11A and FIG. 11B becomes h (0<h<1) is set as the threshold value k. In other words, the value of the threshold value k changes according to each of the probability density functions differing depending on each time period. The user only needs to designate the value of the reference value h through the input interface 21 of the information terminal device 2, and since this number is a probability, it is easy to set.

If the determination result is negative (FIG. 7/STEP174 . . . NO), the series of processes is ended. On the other hand, when the determination result is positive (FIG. 7/STEP174 . . . YES), the second output processing element 122 generates the collected text at that time as a first target text group T1 (FIG. 7/STEP176).

Next, the second output processing element 122 selects most frequently occurring words from the first target text group T1 to generate a first word set W1 (FIG. 7/STEP178). Words of an occurrence frequency of r % (e.g., r=70) or higher of the most frequently occurring words are selected to generate a second word set W2 (FIG. 7/STEP180). In order to prevent vote splitting due to notation fluctuations and synonyms, a process for selecting quasi-most frequently occurring words is introduced. The second output processing element 122 selects nouns from the first word set W1 and the second word set W2 to generate a third word set W3 (FIG. 7/STEP182).

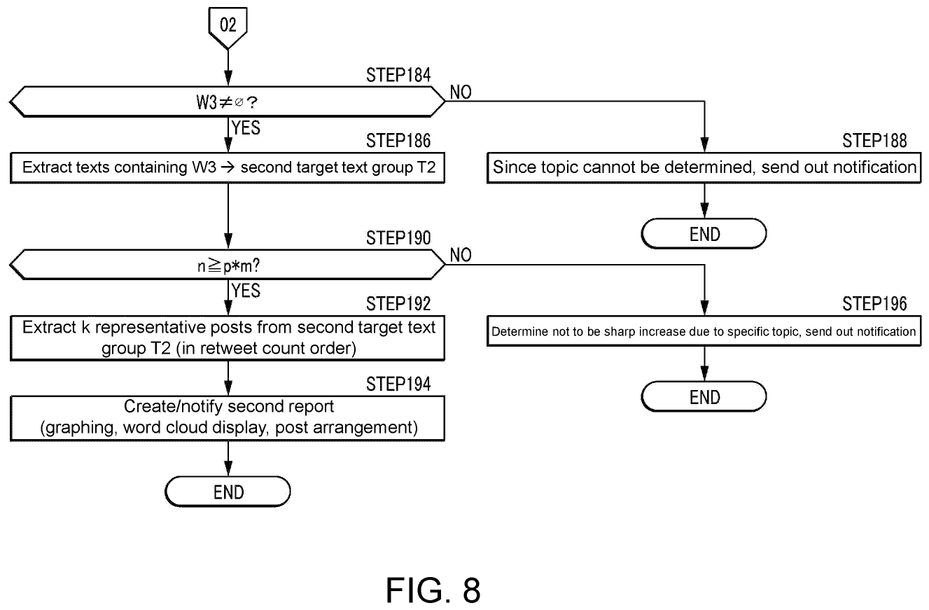

Further, the second output processing element 122 determines whether the third word set W3 is not an empty set ϕ (FIG. 8/STEP 184). When it is determined that the third word set W3 is an empty set ϕ (FIG. 8/STEP184 . . . NO), since the topic cannot be determined, a notification is sent out (FIG. 8/STEP188), and the series of processes is ended. When it is determined that the third word set W3 is not an empty set ϕ (FIG. 8/STEP184 . . . YES), the second output processing element 122 extracts texts containing the words constituting the third word set W3 to generate a second target text group T2 (FIG. 8/STEP186).

The second output processing element 122 determines whether a number n of components of the second target text group T2 is equal to or greater than a product p×m (second predetermined value) of a coefficient p (0<p<1, e.g., p=0.5) and a number m of the components of the first target text group T1 (FIG. 8/STEP190).

When the determination result is negative (FIG. 8/STEP190 . . . NO), it is determined that the occurrence frequency of texts has not increased sharply due to a specific topic, and a notification is sent out (FIG. 8/STEP196), and the series of processes is ended.

On the other hand, when the determination result is positive (FIG. 8/STEP190 . . . YES), the second output processing element 122 extracts k representative posts (e.g., k=2) from the second target text group T2 (e.g., in a descending order of retweet counts) (FIG. 8/STEP 192).

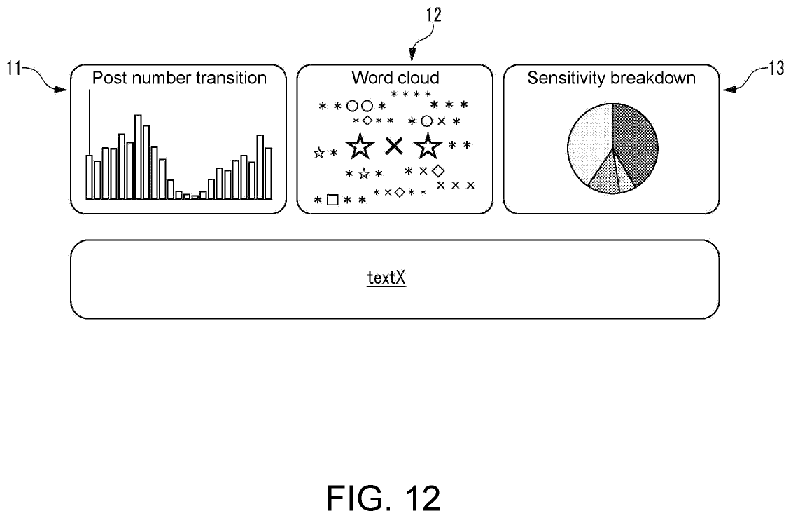

Then, the second output processing element 122 creates a second report, notifies to the information terminal device 2 via the network, and outputs the second report on the output interface 22 of the information terminal device 2 (FIG. 8/STEP194). Accordingly, for example, as shown in FIG. 12, a bar graph I1 which shows a time series (i.e., every 30 minutes) of an occurrence frequency of second target texts, i.e., components of the second target text group T2, in a most recent designated period (e.g., one day), a word cloud I2 in which words that are preferentially extracted in a descending order of a count of being contained in the second target texts are randomly arranged, and a pie chart I3 which shows an occurrence frequency of the sensitivity information in the second target texts for each lower sensitivity category are outputted on the output interface 22. On the output interface 22, each sector constituting the pie chart I3 may be outputted in an identifiable manner by a difference in color or the like according to a difference in the lower sensitivity category or the upper sensitivity category to which the lower sensitivity category belongs.

In addition, as shown in FIG. 12, a part of the extracted second target texts textX, . . . may be outputted on the output interface 22. On the output interface 22, words corresponding to the sensitivity information constituting the second target texts textX, . . . may be outputted in an identifiable manner by a difference in color or the like according to a difference in the upper sensitivity category and/or the lower sensitivity category.

Based on the above processes, it is determined whether the sharp increase in the occurrence frequency of the target texts arises from a single topic or arises from a plurality of unrelated topics that happen to overlap at the same time period, and when it is determined that the sharp increase in texts arises from a single topic, the topic is notified as a true sharp increase topic.

### Operation Effect

According to the information management system 1 having the above configuration, among public information related to a plurality of entities Eᵢ, at least a part of primary texts among a plurality of primary texts constituting a primary text group described respectively in a plurality of different languages is translated into a designated language (see FIG. 2/STEP102→ . . . STEP110, FIG. 3/arrow X120). As a result, the primary text group composed of the plurality of primary texts is converted into a secondary text group composed of a plurality of secondary texts described in the designated language (see FIG. 2/STEP112, FIG. 3/arrow X21 and arrow X22). Then, each of the plurality of secondary texts is associated with sensitivity information extracted from each of the plurality of secondary texts and a sensitivity category of the sensitivity information to construct a database (database server 10) (see FIG. 2/STEP114 STEP118). Since the database is constructed based on a plurality of different languages, the amount of information in the database is increased, and thus the usefulness and convenience are improved.

Further, based on a designated item (an entity (first designated element item) and a keyword (second designated element item)) inputted through the input interface 21, a designated text group which is a part of the secondary text group is searched from the database and then saved in a queue (see FIG. 4/STEP120→ . . . STEP124→ . . . STEP132, FIG. 4/STEP120→ . . . STEP131→STEP133). Further, designated texts of a designated number are extracted from the designated text group preferentially in an order according to one designated priority item designated among a plurality of designated priority items (sensitivity amount and latest information (information freshness)), and a first report is outputted on the output interface 22 (see FIG. 5/STEP136 . . . 1→STEP138→STEP142, FIG. 5/STEP136 . . . 2→STEP140→STEP142). Accordingly, it is possible to enable the user in contact with the output interface 22 to learn about a time series of an occurrence frequency of the designated texts of the designated number (see FIG. 10).

Further, based on a part of designated element items (an entity (first designated element item)) among the plurality of designated element items constituting the designated item, a target text group which is a part of the secondary text group is searched from the database (see FIG. 6/STEP160 and FIG. 7/STEP170). Accordingly, although narrowed down from all occurring texts by a part of designated element items, a text group larger than the designated text group (and including the designated text group) is extracted as a target text group as there are no restrictions of designated element items other than the part of designated element items.

Further, based on a histogram of an occurrence frequency of target texts constituting the target text group, a probability density function of the occurrence frequency of the target texts is generated (see FIG. 6/STEP164, FIG. 11A and FIG. 11B). Further, on the condition that the probability of an occurrence frequency of first target texts constituting a first target text group according to the probability density function is equal to or less than a reference value, it is determined that the occurrence frequency of the first target texts has increased sharply (see FIG. 7/STEP174 . . . YES).

The first target text group T1 is another target text group which occurs after the target text group used for generating the probability density function. Then, a second report showing a time series of an occurrence frequency of the first target texts including a time period in which the occurrence frequency of the first target texts constituting the first target text group T1 has increased sharply is outputted on the output interface 22 (see FIG. 8/STEP194). Accordingly, it is possible to enable the user in contact with the output interface 22 to learn about the time series of the occurrence frequency of the first target texts and further learn about the sharp increase in the occurrence frequency of the first target texts (see FIG. 12).

### Other Embodiments of the Disclosure

In the above embodiment, machine translation is adopted as the designated translation method. However, any method may be adopted as long as the second text group can be translated into the first language, e.g., the second text group being translated into the first language through a translation operation performed by a translator or a complementary operation of machine translation performed by a translator.

In the above embodiment, the sensitivity categories are classified in two classes (upper sensitivity category and lower sensitivity category). However, as another embodiment, the sensitivity categories may be classified in only one class, or may be classified in three or more classes.

What is claimed is:

1. An information management system comprising:
a first input processing element which performs a designated filter process on public information related to each of a plurality of entities to acquire a primary text group composed of a plurality of primary texts respectively described in a plurality of different languages, and translates at least a part of the primary texts constituting the primary text group into a designated language to convert the primary text group into a secondary text group composed of a plurality of secondary texts described in the designated language;
a second input processing element which extracts sensitivity information respectively from each of the plurality of secondary texts constituting the secondary text group and classifies the sensitivity information into each of a plurality of sensitivity categories, and then constructs a database in which the sensitivity information respectively classified into each of the plurality of sensitivity categories and each of the plurality of secondary texts are associated with each other;
a first output processing element which, based on a designated item inputted through an input interface, searches for a designated text group that is a part of the secondary text group from the database constructed by the second input processing element and then saves the designated text group to a queue; and
a second output processing element which extracts designated texts of a designated number from the designated text group preferentially in an order according to one designated priority item designated among a plurality of different designated priority items through the input interface, and outputs a first report including a time series of an occurrence frequency of the designated texts of the designated number on an output interface.

2. The information management system according to claim 1, wherein when a number of the designated texts constituting the designated text group is equal to or greater than a threshold value, the first output processing element aggregates overlapping designated texts which are a part of the designated text group so that the number is less than the threshold value.

3. The information management system according to claim 1, wherein the first output processing element searches for a first designated text group which is a part of the secondary text group from the database and then saves the first designated text group to a first queue based on a first designated item taken as the designated item, and searches for a second designated text group which is a part of the first designated text group and then saves the second designated text group to a second queue based on the first designated item and a second designated item taken as the designated item, and
the second output processing element extracts the designated texts of the designated number from the designated text group derived from the first designated text group preferentially in an order according to a first designated priority item taken as the designated priority item, and extracts the designated texts of the designated number from the designated text group derived from the second designated text group preferentially in an order according to a second designated priority item taken as the designated priority item.

4. The information management system according to claim 2, wherein the first output processing element searches for a first designated text group which is a part of the secondary text group from the database and then saves the first designated text group to a first queue based on a first designated item taken as the designated item, and searches for a second designated text group which is a part of the first designated text group and then saves the second designated text group to a second queue based on the first designated item and a second designated item taken as the designated item, and
the second output processing element extracts the designated texts of the designated number from the designated text group derived from the first designated text group preferentially in an order according to a first designated priority item taken as the designated priority item, and extracts the designated texts of the designated number from the designated text group derived from the second designated text group preferentially in an order according to a second designated priority item taken as the designated priority item.

5. The information management system according to claim 1, wherein the second output processing element outputs, on the output interface, the first report further including an occurrence frequency of sensitivity information extracted from the designated texts of the designated number for each of the sensitivity categories.

6. The information management system according to claim 2, wherein the second output processing element outputs, on the output interface, the first report further including an occurrence frequency of sensitivity information extracted from the designated texts of the designated number for each of the sensitivity categories.

7. The information management system according to claim 3, wherein the second output processing element outputs, on the output interface, the first report further including an occurrence frequency of sensitivity information extracted from the designated texts of the designated number for each of the sensitivity categories.

8. The information management system according to claim 1, wherein the second output processing element outputs, on the output interface, the first report further including a word cloud according to words extracted in a descending order of an occurrence frequency in the designated texts of the designated number.

9. The information management system according to claim 2, wherein the second output processing element outputs, on the output interface, the first report further including a word cloud according to words extracted in a descending order of an occurrence frequency in the designated texts of the designated number.

10. The information management system according to claim 3, wherein the second output processing element outputs, on the output interface, the first report further including a word cloud according to words extracted in a descending order of an occurrence frequency in the designated texts of the designated number.

11. The information management system according to claim 5, wherein the second output processing element outputs, on the output interface, the first report further including a word cloud according to words extracted in a descending order of an occurrence frequency in the designated texts of the designated number.

12. The information management system according to claim 1, wherein based on a part of designated element items among a plurality of designated element items constituting the designated item, the first output processing element searches for a target text group which is a part of the secondary text group from the database, and generates a probability density function of an occurrence frequency of target texts constituting the target text group based on a histogram of the occurrence frequency of the target texts, and
on a condition that a probability of an occurrence frequency of first target texts constituting a first target text group according to the probability density function is less than or equal to a reference value, the second output processing element outputs, on the output interface, a second report including a time series of the occurrence frequency of the first target texts including a time period in which the occurrence frequency of the first target texts has increased sharply.

13. The information management system according to claim 2, wherein based on a part of designated element items among a plurality of designated element items constituting the designated item, the first output processing element searches for a target text group which is a part of the secondary text group from the database, and generates a probability density function of an occurrence frequency of target texts constituting the target text group based on a histogram of the occurrence frequency of the target texts, and
on a condition that a probability of an occurrence frequency of first target texts constituting a first target text group according to the probability density function is less than or equal to a reference value, the second output processing element outputs, on the output interface, a second report including a time series of the occurrence frequency of the first target texts including a time period in which the occurrence frequency of the first target texts has increased sharply.

14. The information management system according to claim 3, wherein based on a part of designated element items among a plurality of designated element items constituting the designated item, the first output processing element searches for a target text group which is a part of the secondary text group from the database, and generates a probability density function of an occurrence frequency of target texts constituting the target text group based on a histogram of the occurrence frequency of the target texts, and
on a condition that a probability of an occurrence frequency of first target texts constituting a first target text group according to the probability density function is less than or equal to a reference value, the second output processing element outputs, on the output interface, a second report including a time series of the occurrence frequency of the first target texts including a time period in which the occurrence frequency of the first target texts has increased sharply.

15. The information management system according to claim 5, wherein based on a part of designated element items among a plurality of designated element items constituting the designated item, the first output processing element searches for a target text group which is a part of the secondary text group from the database, and generates a probability density function of an occurrence frequency of target texts constituting the target text group based on a histogram of the occurrence frequency of the target texts, and
on a condition that a probability of an occurrence frequency of first target texts constituting a first target text group according to the probability density function is less than or equal to a reference value, the second output processing element outputs, on the output interface, a second report including a time series of the occurrence frequency of the first target texts including a time period in which the occurrence frequency of the first target texts has increased sharply.

16. The information management system according to claim 12, wherein the first output processing element generates a plurality of the probability density functions respectively for a plurality of different unit periods, and
on a condition that the probability according to the probability density function corresponding to a time period in which the first target text group occurs is equal to or less than the reference value, the second output processing element determines that the occurrence frequency of the first target texts has increased sharply and outputs the second report including a time series of the occurrence frequency of the first target texts on the output interface.

17. The information management system according to claim 12, wherein on a condition that an occurrence frequency of second target texts constituting a second target text group which is a part of the target text group is equal to or greater than a second predetermined value, the second output processing element outputs the second report including a time series of the occurrence frequency of the first target texts on the output interface, wherein the second target texts contain words whose occurrence frequency in the first target text group is equal to or greater than a first predetermined value.

18. The information management system according to claim 17, wherein the second output processing element outputs, on the output interface, the second report further including an occurrence frequency of sensitivity information extracted from the second target text group for each of the sensitivity categories.

19. The information management system according to claim 12, wherein the second output processing element outputs, on the output interface, the second report further including a word cloud according to words extracted in a descending order of an occurrence frequency in the first target text group.

20. The information management system according to claim 1, wherein after removing noise from each of the plurality of secondary texts, the second input processing element constructs a database by associating the sensitivity information with each of the plurality of secondary texts from which the noise has been removed.
